(19) United States
(12) Patent Application Publication
(10) Pub. No.: US 2010/0328430 A1
(43) Pub. Date: Dec. 30, 2010

(54) LENS MODULE FOR FORMING STEREO IMAGE

(75) Inventor: CHUN-YU LEE, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/692,505

(22) Filed: Jan. 22, 2010

(30) Foreign Application Priority Data
Jun. 26, 2009 (CN) 200910303724.2

(51) Int. Cl. H04N 13/02

(52) U.S. Cl. 348/46; 348/E13.074

(57) ABSTRACT

The disclosure provides a lens module for forming a stereo image. The lens module includes a point light source, a two-dimensional scanning unit, a camera sensor unit, and a data processing unit. The two-dimensional scanning unit is configured for controlling the light from the point light source to project onto an object to obtain image points, which are reflected and arrayed in a matrix on the object and scanning the image points. The camera sensor unit is configured for receiving the light reflected by the object and capturing an image of the image points. The data processing unit is configured for receiving the image from the camera sensor unit and performing an analysis on the image to obtain depth information of the object.

### BACKGROUND

1. Technical Field

The disclosure relates to lens modules and, more particularly, to a lens module for forming a stereo image.

2. Description of the Related Art

In a conventional stereo image capturing system, two cameras are needed, wherein, one camera is used for taking a photograph of an object from one angle and the other is used for taking a photograph of the object from another angle. The two images are then integrated into a stereo image of the object according to the relative positions of the two cameras. However, the conventional system including the two cameras has a high cost and is bulky.

### BRIEF DESCRIPTION OF THE DRAWINGS

The components in the drawings are not necessarily drawn to scale, the emphasis instead being placed upon clearly illustrating the principles of the lens module. Moreover, in the drawings, like reference numerals designate corresponding parts throughout the several views.

FIG. 1 is a schematic view of a lens module for forming a stereo image in accordance with an embodiment.

FIG. 2 is a schematic view of a lens module for forming a stereo image in accordance with another embodiment.

### DETAILED DESCRIPTION

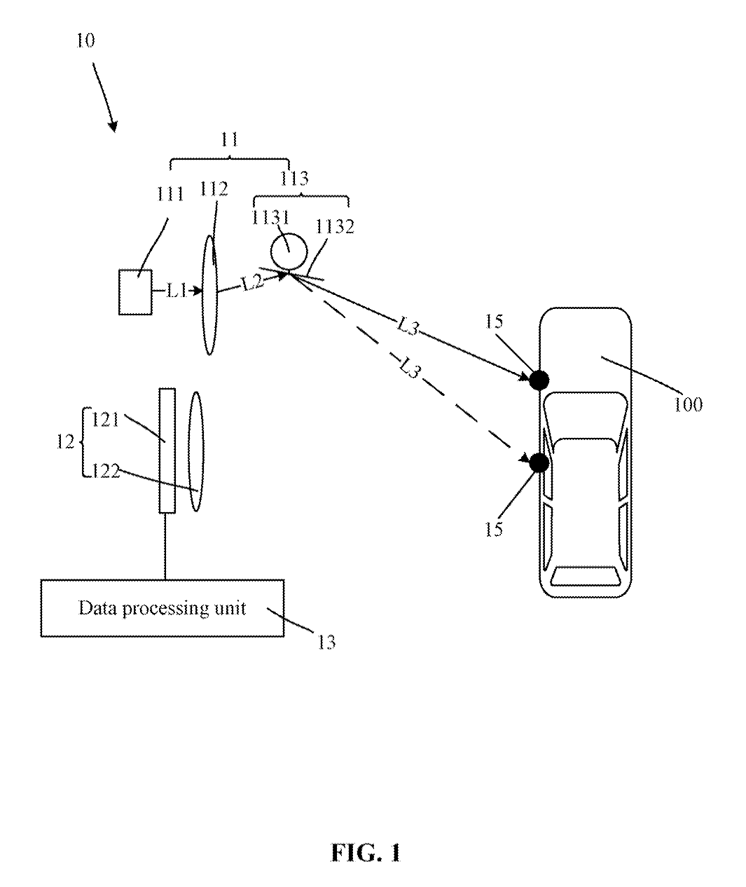

FIG. 1 is a schematic view of a lens module for forming a stereo image in accordance with an embodiment. The lens module for forming a stereo image (hereinafter “the lens module”) 10 includes a light-scanning unit 11, a camera sensor unit 12, and a data processing unit 13. The light-scanning unit 11 further includes a point light source 111, a collimating lens 112, and a two-dimensional scanning module 113. The collimating lens 112 is configured for collimating light from the point light source 111. The two-dimensional scanning module 113 is configured for controlling the light to project onto an object 100 to obtain image points 15, which are reflected and arrayed in a matrix on the object 100. The two-dimensional scanning module 113 is further configured for scanning the image points 15.

The two-dimensional scanning module 113 further includes a motor 1131 and a flat mirror 1132. The motor 1131 is configured for manipulating the flat mirror 1132 to rotate according to predetermined orientations. Lights can then be reflected by the flat mirror 1132 and projected onto the object 100 to form an array of the image points 15. In this embodiment, the point light source 111 is an infrared point light source. The point light source 111 emits light L1 through the collimating lens 112 which is then referred to as light L2, and the light L2 is reflected as light L3 by the flat mirror 1132 to form the image points 15 on the object 100.

The light emitted by the point light source 111 is arrayed in a predetermined shape by the point light source 111, for example, a circle, a rectangle, a square, a circle containing a cross etc. The shape of the image points 15 on the object 100 is the same as that of the light emitted by the point light source 111. The shape can be defined by a plurality of parameters, such as, a length parameter and a width parameter, and so on. In this embodiment, the shape of the image points 15 is a circle containing a cross, and the cross is formed by a horizontal width and a vertical width of the image points 15. The motor 1131 manipulates the flat mirror 1132 to rotate so that the image points 15 can be arrayed on different portions of the object 100.

The camera sensor unit 12 further includes an image sensor module 121 and a lens module 122. The light L3 from the object 100 is reflected to the lens module 122 and the image sensor module 121 captures an image of the image points 15. The image sensor module 121 may be a charge coupled device (CCD) sensor or a complementary metal oxide semiconductor (CMOS) sensor.

The data processing unit 13 is configured for receiving the image from the image sensor module 121 and performing a Fourier analysis on the image to obtain spatial information of all the image points 15. The spatial information includes, but is not limited to, length information, width information, depth information etc. The data processing unit 13 is further configured for integrating the spatial information of the image points 15 and thus to obtain spatial information of the image of the object 100 and form a stereo image of the object 100.

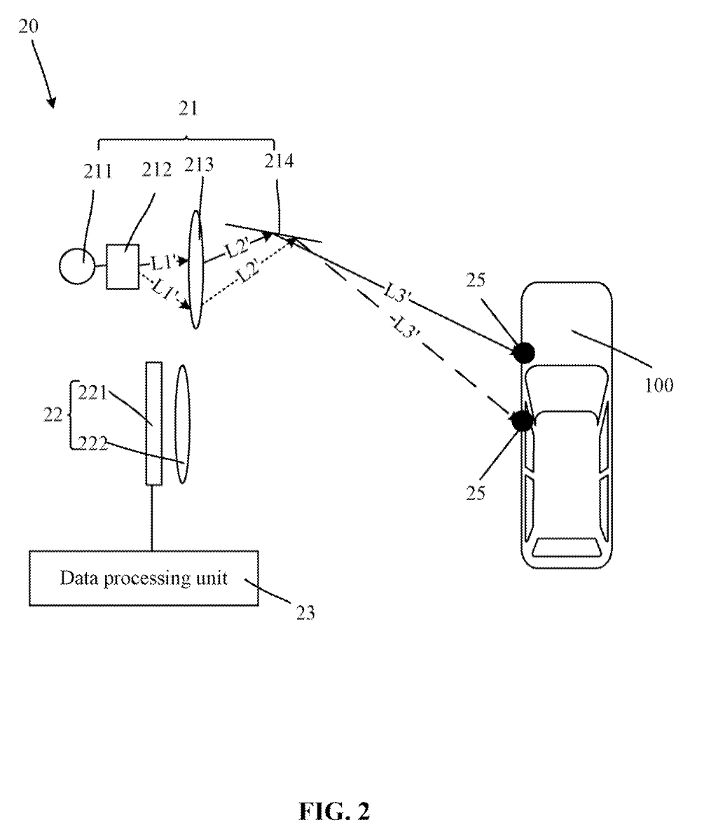

FIG. 2 is a schematic view of a lens module for forming a stereo image in accordance with another embodiment. The lens module 20 for forming a stereo image 20 includes a light-scanning unit 21, a camera sensor unit 22, and a data processing unit 23. The light-scanning unit 21 further includes a motor 211, a point light source 212, a collimating lens 213, and a micromirror array component 214. The point light source 212 is the same as the point light source 111 in FIG. 1. In this embodiment, the micromirror array component 214 is a digital micromirror device (DMD). The camera sensor unit 22 is the same as the camera sensor unit 12 in FIG. 1. The data processing unit 23 is the same as the data processing unit 13 in FIG. 1.

The motor 211 is configured for manipulating the point light source 212 to rotate according to predetermined orientations, so that light can be reflected by the micromirror array component 214 and projected onto the object 100 to form an array of image points 25 on different portions of the object 100. The point light source 212 emits light L1′ through the collimating lens 213 to become light L2′, the light L2′ is reflected by the micromirror array component 214 as light L3′ to the different portions of the object 100 to obtain the image points 25. The object 100 reflects light L3′ to the lens module 222 and the image sensor module 221 captures an image of the image points 25.

The same as in FIG. 1, the data processing unit 23 receives the image from the camera sensor unit 22 and performs the Fourier analysis on the image to obtain spatial information of all the image points 25, such as length information, width information, depth information etc. The data processing unit 23 integrates the spatial information of the image points 25 and thus to obtain spatial information of the image of the object 100 and form a stereo image of the object 100.

It is understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A lens module for forming a stereo image, comprising:
a point light source;
a two-dimensional scanning unit configured for controlling the light from the point light source to project onto an object to obtain image points, which are reflected and arrayed in a matrix on the object and scanning the image points;
a camera sensor unit configured for receiving the light reflected by the object and capturing an image of the image points; and
a data processing unit configured for receiving the image from the camera sensor unit and performing an analysis on the image to obtain depth information of the object.

2. The lens module for forming a stereo image as recited in claim 1, wherein the point light source is an infrared point light source.

3. The lens module for forming a stereo image as recited in claim 2, wherein the two-dimensional scanning unit further comprises a motor and a flat mirror, the motor is configured for manipulating the flat mirror to rotate, and the infrared light from the infrared point light source is reflected by the flat mirror to the object.

4. The lens module for forming a stereo image as recited in claim 2, wherein the two-dimensional scanning unit further comprises a motor and a micromirror array component, the motor is configured for manipulating the infrared light from the infrared point light source to the micromirror array component, and the infrared light is reflected by the micromirror array component to the object.

5. The lens module for forming a stereo image as recited in claim 4, wherein the micromirror array component is a digital micromirror device (DMD).

6. The lens module for forming a stereo image as recited in claim 1, wherein the camera sensor unit further comprises an image sensor module and a lens module, and the light from the object is reflected to the lens module and the image sensor module captures the image of the image points via the lens module.

7. The lens module for forming a stereo image as recited in claim 6, wherein the image sensor module is a charge coupled device (CCD) sensor or a complementary metal oxide semiconductor (CMOS) sensor.

8. The lens module for forming a stereo image as recited in claim 1, wherein the data processing unit performs a Fourier analysis on the image to obtain the depth information of the object.
